(19) United States
(12) Patent Application Publication
(10) Pub. No.: US 2026/0269748 A1
(43) Pub. Date: Sep. 10, 2026

(54) SELF-POWERED WHEEL STRUCTURE AND VEHICLE WITH THE SAME

(71) Applicant: HON HAI PRECISION INDUSTRY CO., LTD., New Taipei (TW)

(72) Inventors: CHIH-CHENG LEE, New Taipei (TW); JYUN-LIN JIANG, New Taipei (TW); CHI-LIN WU, New Taipei (TW); CHENG-HUNG CHEN, New Taipei (TW); CHIUNG-HSIANG WU, New Taipei (TW); CHIH-TE HUNG, New Taipei (TW); YU-CHENG ZHANG, New Taipei (TW); SHENG-LI YEN, New Taipei (TW); YI-LUN WEI, New Taipei (TW); CHEN-TING KAO, New Taipei (TW); CHEN CHAO, New Taipei (TW); CHUNG-WEI LU, New Taipei (TW); HSIU-HAO CHENG, New Taipei (TW); KAI FAN CHIANG, New Taipei (TW); CHIH-HAO KUO, New Taipei (TW)

(21) Appl. No.: 19/365,475

(22) Filed: Oct. 22, 2025

(30) Foreign Application Priority Data
Mar. 5, 2025 (CN) 202520368940.X

(51) Int. Cl. H02N 2/18; B60B 3/10; B60B 27/00; B60C 7/14; B60L 50/60

(52) U.S. Cl. CPC H02N 2/18; B60B 3/10; B60B 27/0047; B60C 7/146; B60L 50/60

(57) ABSTRACT

The present disclosure provides a self-powered wheel structure and a vehicle having the same. The wheel structure includes a tire unit, a hub unit, and a plurality of first power generation units. The hub unit includes a hub, a spoke, and a rim, the hub is disposed at the center of the rim. The rim is coaxially arranged with the hum. The spoke connects the hub and the rim. The tire unit and the rim cooperatively define a cavity for containing gas. The first power generation unit includes a metal ball, a magnetic member, and a metallic elastic coil. The metal ball is movably disposed within the cavity. The rim defines a through-hole, and the magnetic member penetrates through the through-hole and is movable along the radial direction. Two ends of the metallic elastic coil are abutted against the magnetic member and the hub, respectively.

### CROSS-REFERENCE TO RELATED APPLICATION(S)

The present application claims the benefit and priority to Chinese Patent Application Serial No. 202520368940.X, filed on Mar. 5, 2025, in China State Intellectual Property Administration, and the content of which is hereby fully incorporated by reference into the present application.

### FIELD

The subject matter relates to tire, and more particularly, to a self-powered wheel structure and a vehicle with the self-powered wheel structure.

### BACKGROUND

At present, a regenerative braking system (RBS) in an electric vehicle (EV) is capable of recapturing the kinetic energy released during the operation of the vehicle and converting the kinetic energy into electrical energy, thereby enhancing energy efficiency and extending driving range. The working principle of the RBS is that during deceleration or braking of the vehicle, the motor operates in reverse to convert kinetic energy into electrical energy, which is then stored in the onboard battery, thereby achieving recovery of the kinetic energy.

However, the kinetic energy recovery rate of the RBS is low, and the amount of electricity generated is limited. Therefore, there is room for improvement in the art.

### BRIEF DESCRIPTION OF THE DRAWINGS

Implementations of the present technology will now be described, by way of example only, with reference to the attached figures.

FIG. 1 is a diagrammatic view of a wheel structure according to an embodiment of the present disclosure.

FIG. 2 is an exploded view of an embodiment of the wheel structure shown in FIG. 1.

FIG. 3 is a cross-sectional view of an embodiment along III-III of the wheel structure shown in FIG. 1.

FIG. 4 is a cross-sectional view of an embodiment along IV-IV of the wheel structure shown in FIG. 1.

FIG. 5 is an enlarged view of part A in FIG. 3.

FIG. 6 is a diagrammatic view of the wheel structure without a tire unit shown in FIG. 1.

FIG. 7 is an enlarged view of part B in FIG. 6.

FIG. 8 is a diagrammatic view of a first power generation unit subjected to forces in different directions according to an embodiment of the present disclosure.

FIG. 9 is an enlarged view of part C in FIG. 3.

FIG. 10 is a cross-sectional view of the tire unit shown in FIG. 1.

FIG. 11 is a cross-sectional view of the wheel structure subjected to forces according to an embodiment of the present disclosure.

FIG. 12 is an enlarged view of part D in FIG. 11.

FIG. 13 is a diagrammatic view of a vehicle according to an embodiment of the present disclosure.

### DETAILED DESCRIPTION

It will be appreciated that for simplicity and clarity of illustration, where appropriate, reference numerals have been repeated among the different FIG.s to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

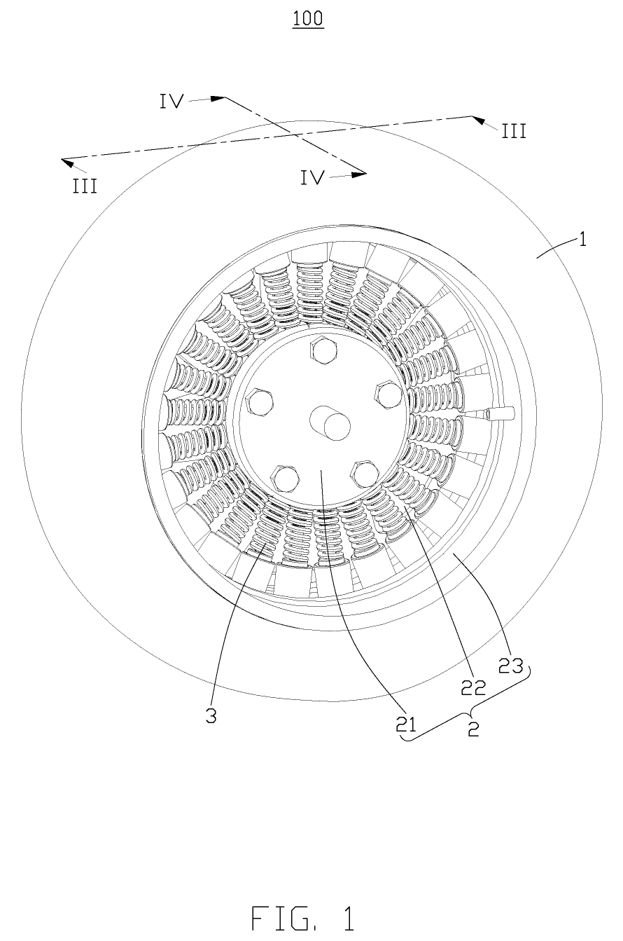

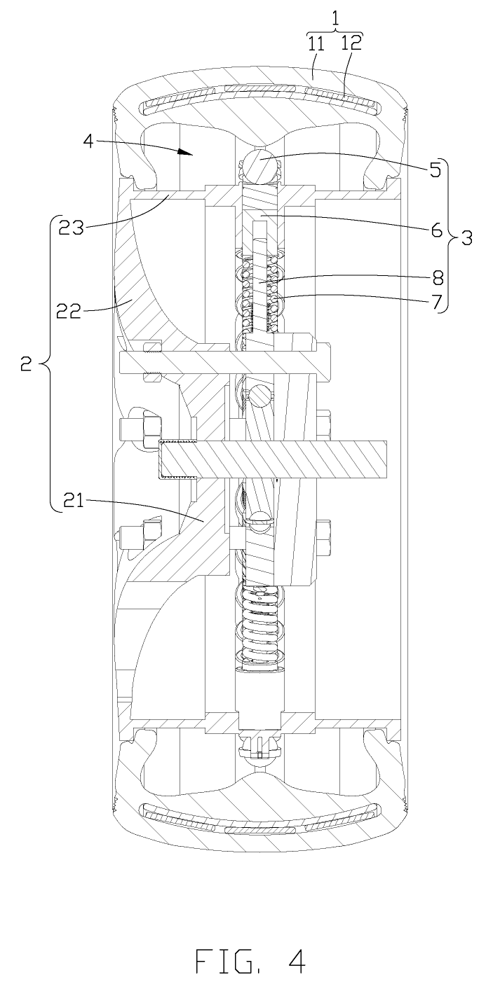

Referring to FIGS. 1 to 4, a self-powered wheel structure 100 is provided according to an embodiment of the present disclosure. The self-powered wheel structure 100 includes a tire unit 1, a hub unit 2, and a plurality of first power generation units 3. The hub unit 2 includes a hub 21, a spoke 22, and a rim 23. The hub 21 is disposed at a center of the rim 23, while the rim 23 is coaxially arranged with the hum 21. The spoke 22 is connected between the hub 21 and the rim 23 in a radiating manner along a radial direction Y. The tire unit 1 is disposed on an outer side of the rim 23. The tire unit 1 and the rim 23 cooperatively define a cavity 4 for containing gas. The first power generation unit 3 is capable of converting the kinetic energy generated during the movement of the wheel structure 100 into electrical energy.

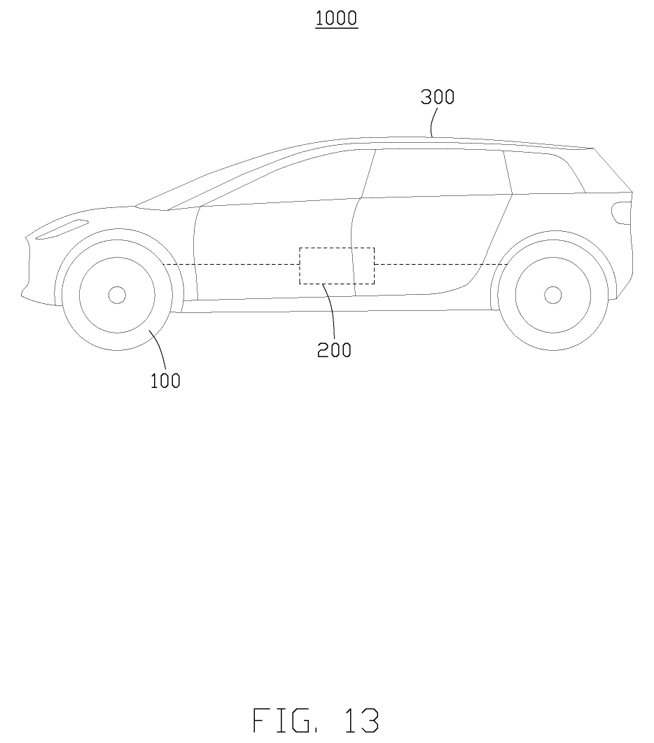

The first power generation unit 3 includes a metal ball 5, a magnetic member 6, and a metallic elastic coil 7 arranged sequentially along the radial direction Y. The metal ball 5 is movably disposed within the cavity 4. the rim 23 defines a through-hole 24 corresponding to the metal ball 5. The through-hole 24 is connected to the cavity 4. The magnetic member 6 penetrates through the through-hole 24 and is movable along the radial direction Y. Two ends of the metallic elastic coil 7 are abutted against the magnetic member 6 and the hub 21, respectively. The metallic elastic coil 7 can be electrically connected to a power storage module 200 (as shown in FIG. 13).

The first power generation unit 3 further includes a guide rod 8 disposed on the hub 21 and extends along the radial direction Y. The metallic elastic coil 7 is sleeved on the guide rod 8. The magnetic member 6 is disposed on an end of the guide rod 8 away from the hub 21, and is movable along the guide rod 8. That is, one end of the guide rod 8 is fixed on the hub 21, while the other end of the guide rod 8 is a free end. The magnetic member 6 is sleeved on the free end of the guide rod 8. The guide rod 8 provides positional limitation for both of the metallic elastic coil 7 and the magnetic member 6, thereby enhancing the coaxial alignment of the metallic elastic coil 7 and the magnetic member 6 during their operational movements.

In some embodiments, an end of the magnetic member 6 close to the hub 21 defines a limiting slot 61. An opening of the limiting slot 61 faces toward the hub 21. The guide rod 8 extends into the limiting slot 61. After the magnetic member 6 is subjected to a force from the metal ball 5, the magnetic member 6 will move along the guide rod 8. A depth of the limiting slot 61 is set according to a travel distance of the magnetic member 6 moving along the radial direction Y.

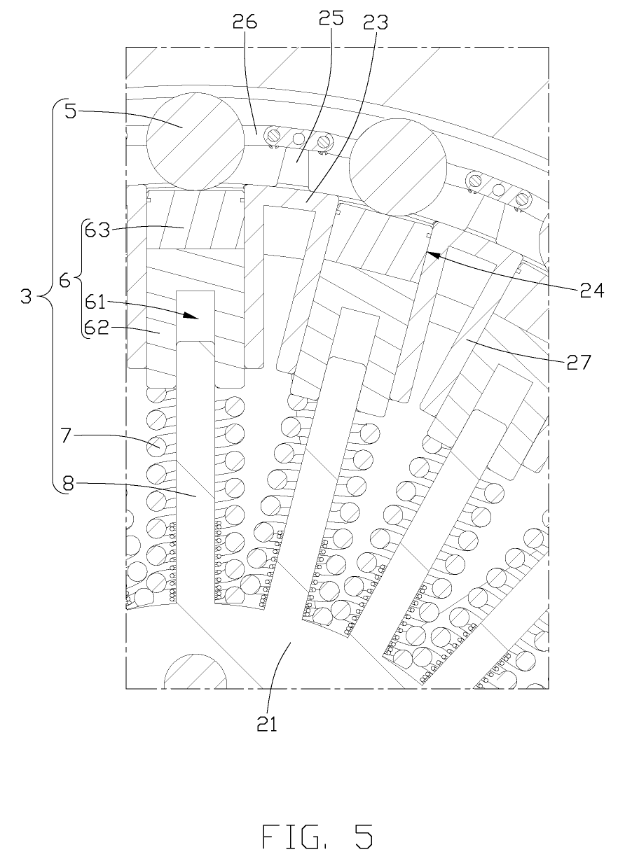

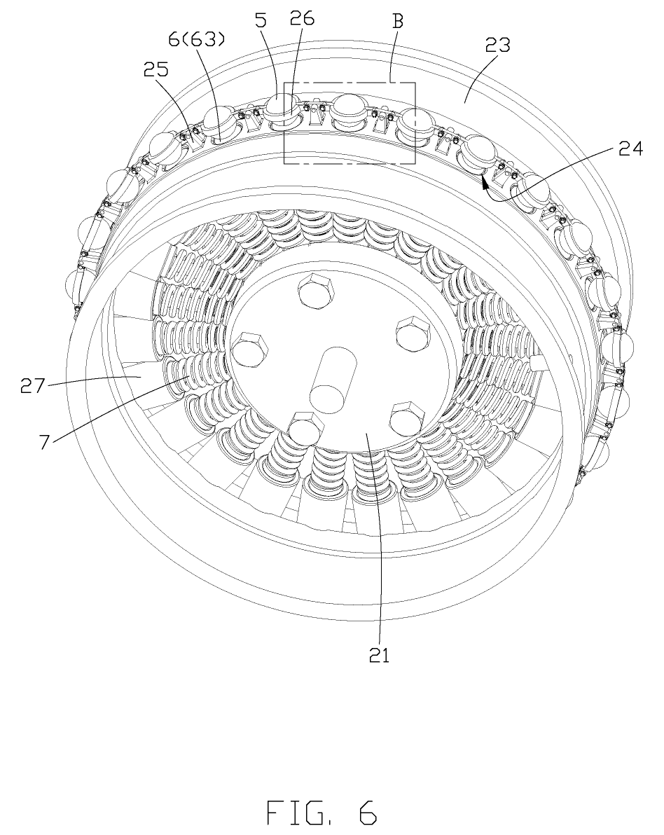

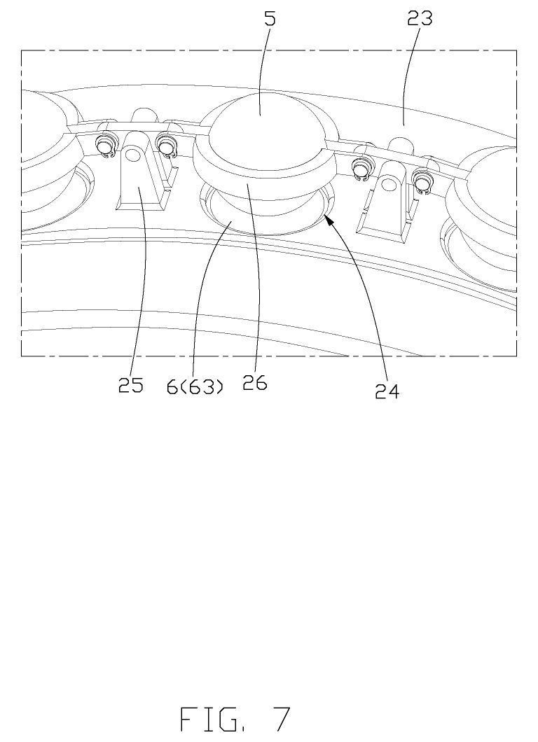

Referring to FIGS. 5 to 7, the hub unit 2 further includes a plurality of posts 25 and a plurality of limiting rings 26. The posts 25 and the limiting rings 26 are disposed on a surface of the rim 23 adjacent to the cavity 4. One limiting ring 26 is installed between two adjacent posts 25. The metal ball 5 is movably disposed in the limiting ring 26. By setting the limiting ring 26 inside the cavity 4, a range of motion of the metal ball 5 can be restricted, ensuring that the metal ball 5 remains in contact with the magnetic member 6 and does not separate from the limiting ring 26 during movement.

In some embodiments, the limiting ring 26 includes two annular portions that are spliced together. The annular portions are detachably connected to each other to form a closed ring, and two ends of each of the annular portions are connected to two adjacent posts 25, respectively. The metal ball 5 is located in the closed ring. The closed ring has an inner surface that matches the outer surface of the metal ball 5, allowing the metal ball 5 to move freely within the limiting ring 26. Moreover, to avoid restricting the movement of the metal ball 5, an inner diameter of the limiting ring 26 is designed to be larger than an outer diameter of the metal ball 5.

Referring to FIGS. 5 to 7, the magnetic member 6 includes a magnetic portion 62 and a sealing portion 63. The sealing portion 63 disposed on an end of the magnetic portion 62 away from the hub 21. The sealing portion 63 is movably sealed in the through-hole 24. Under the force, the sealing portion 63 can reciprocate along the radial direction Y without separating from the through-hole 24, thereby maintaining airtightness. By including the sealing portion 63, the force exerted on the metal ball 5 can be smoothly transmitted to the magnetic portion 62. At the same time, the cavity 4 can also remain sealed, preventing air leakage from the wheel structure 100.

In some embodiments, a material of the sealing portion 63 is rubber, which can enhance the sealing performance. The magnetic portion 62 is a magnet. The magnetic portion 62 and the sealing portion 63 can be an integrated structure. The sealing portion 63 can be formed by injecting rubber onto the end of the magnetic portion 62.

Referring to FIGS. 5 to 7, the hub unit 2 further includes a plurality of fixed sleeves 27 disposed on a surface of the rim 23 facing the hub 21. The fixed sleeves 27 are disposed outside the through-hole 24. The magnetic member 6 is movably disposed within the fixed sleeve 27. The fixed sleeve 27 can further restrict the movement of the magnetic member 6, enhancing its stability during motion and improving the coaxial alignment between the magnetic member 6 and the metallic elastic coil 7. Additionally, the fixed sleeve 27 does not affect the movement of the magnetic member 6.

In some embodiments, the fixed sleeves 27 and the rim 23 are integrally formed.

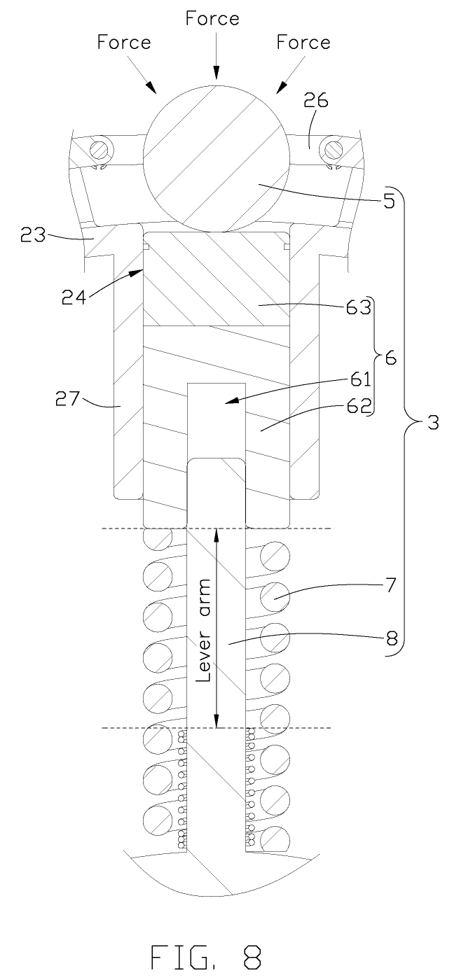

The metallic elastic coil 7 can be electrically connected to the power storage module 200 (as shown in FIG. 13) via conductive wires. The metallic elastic coil 7 may be a metal spring coil, such as a copper coil. As shown in FIG. 8, the metallic elastic coil 7 has a certain length, with a segment near the magnetic member 6 forming a lever arm. When the direction of the force applied on the metal ball 5 changes, an extension direction of the lever arm of the metallic elastic coil 7 will be adjusted accordingly, ensuring that the force passes through the centroid of the metal ball 5. Thus, the sensitivity of the first power generation unit 3 will be enhanced. Furthermore, the first power generation unit 3 can convert forces from various directions into electrical energy, thereby improving the mechanical energy recovery rate.

Referring to FIGS. 1 to 4, by adjusting the quantity and layout of the first power generation unit 3, more kinetic energy can be recovered. A density of the first power generation unit 3 can be controlled by adjusting an included angle between two adjacent first power generation units 3. The included angle is set under a premise that the operation of two adjacent first power generation units 3 do not interfere with each other. Furthermore, the number of first power generation units 3 depends on a size of the hub unit 2. The maximum number of first power generation units 3 enable full recovery of kinetic energy of the hub unit 2 with a fixed size.

In some embodiments, the first power generation units 3 are disposed circumferentially around the hub unit 2.

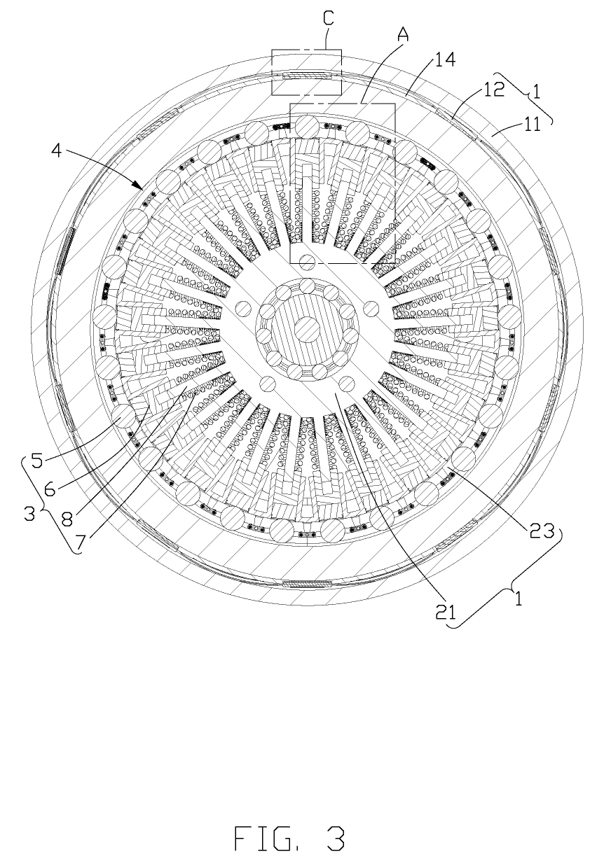

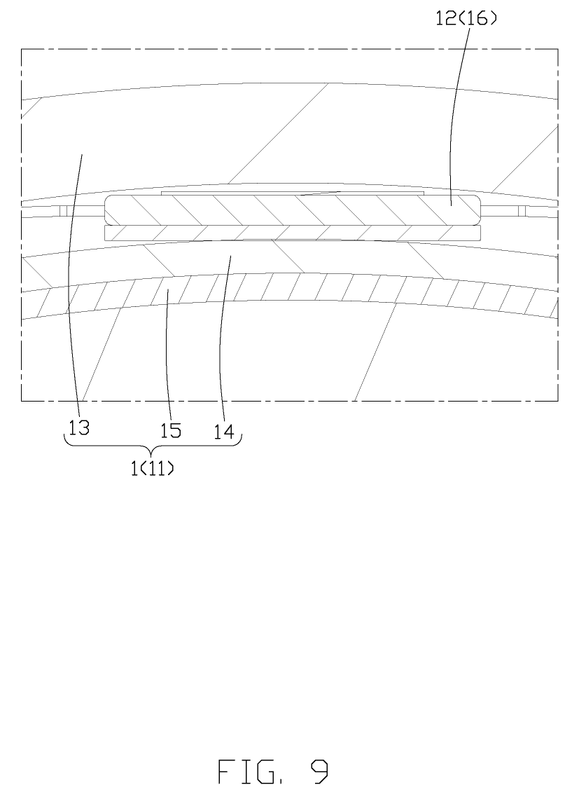

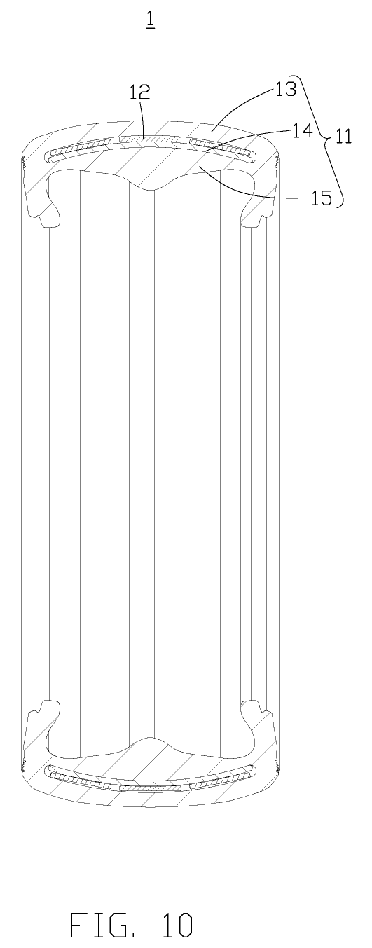

Referring to FIGS. 3, 4, 9, and 10, the tire unit 1 includes a tire 11 and a plurality of second power generation units 12. The tire 11 includes a rubber layer 13, a functional layer 14, and an airtight layer 15 sequentially disposed from an outer side to an inner side of the tire 11. The second power generation units 12 are distributed in the functional layer 14. The second power generation unit 12 includes a plurality of piezoelectric elements 16. The piezoelectric elements 16 are configured to electrically connect to a power storage module 200 (as shown in FIG. 13). The second power generation unit 12 offers higher mechanical strength and greater electrical power output.

In some embodiments, the tire 11 may include a plurality of functional layers 14, and the second power generation unit 12 can be disposed between any two adjacent functional layers 14. For instance, the functional layers 14 may include, from the outer to the inner layer, sequentially arranged layers such as a nylon belt layer (not shown), a steel wire layer (not shown), and a fabric ply layer (not shown). The second power generation unit 12 can be distributed between two adjacent layers among the nylon belt layer, steel wire layer, fabric ply layer, and airtight layer 15. Positioning the second power generation unit 12 on the inner side of the nylon belt layer and on the outer side of the airtight layer 15 ensures sensitivity in pressure sensing without affecting the airtightness of the tire 11, thereby enhancing the service life of the tire 11.

In some embodiments, the piezoelectric element 16 can be a piezoelectric ceramic chip or a PVDF (Polyvinylidene Fluoride) diaphragm.

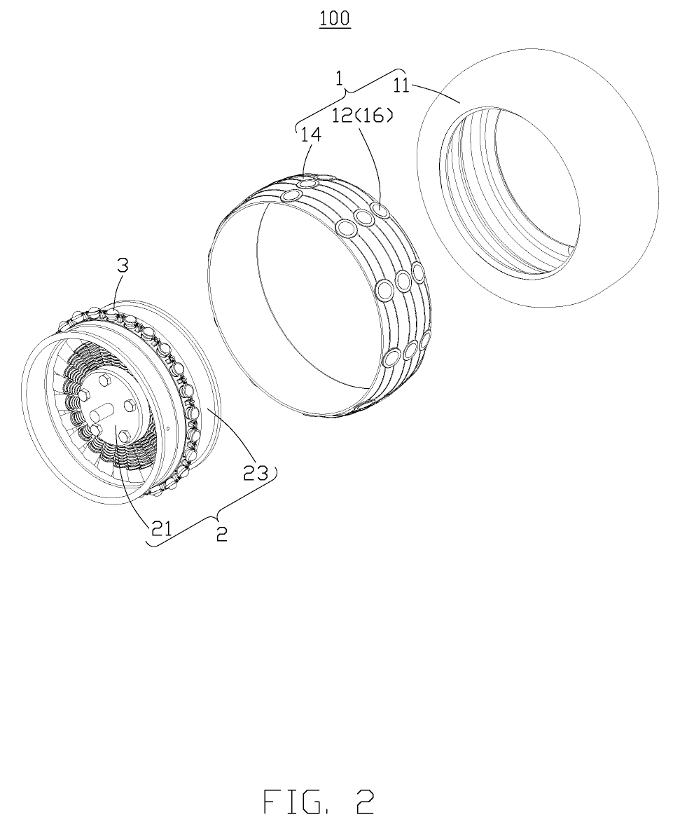

Referring to FIGS. 2, 9, and 10, the piezoelectric elements 16 can be arranged in an array. In some embodiments, a plurality of rows of piezoelectric elements 16 can be disposed along a width direction of the tire 11, enabling the conversion of deformations occurring at different positions on the tire 11 into electrical energy. The piezoelectric elements 16 are interconnected electrically with each other and led out via conductive wires.

Referring to FIG. 2, the second power generation unit 12 further includes a carrier layer. The piezoelectric elements 16 can be arranged in an array on the carrier layer. The piezoelectric elements 16 can be pre-fixed onto the carrier layer before being installed into the tire 11, facilitating the installation process. In some embodiments, the carrier layer can be one of the functional layers 14.

In the self-powered wheel structure 100, the piezoelectric elements 16 are densely arranged in the inner layer of the tire 11. When the tire 11 contacts the ground or other foreign objects, the tire 11 deforms. When the tire 11 rotates away from the ground or the foreign objects, the deformation recovers. Then the deformation of the tire 11 may transfer to the piezoelectric elements 16, thereby changing the magnetic field lines to generate electricity. Furthermore, the deformation of the tire 11 may be transmitted to the internal metal ball 5, which pushes the magnetic member 6 to change the magnetic field lines within the metallic elastic coil 7 and to generate electricity through Faraday's law of electromagnetic induction.

The self-powered process of the wheel structure 100 is described as follows.

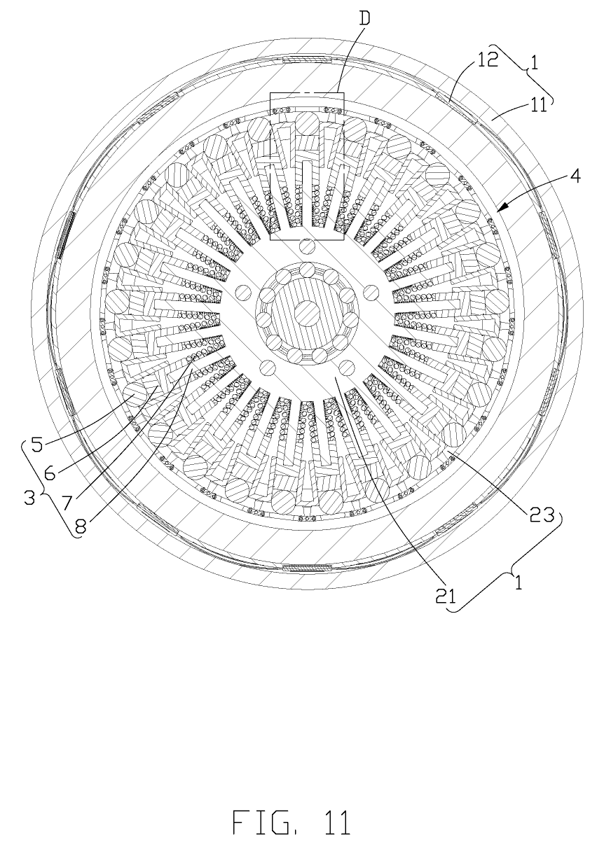

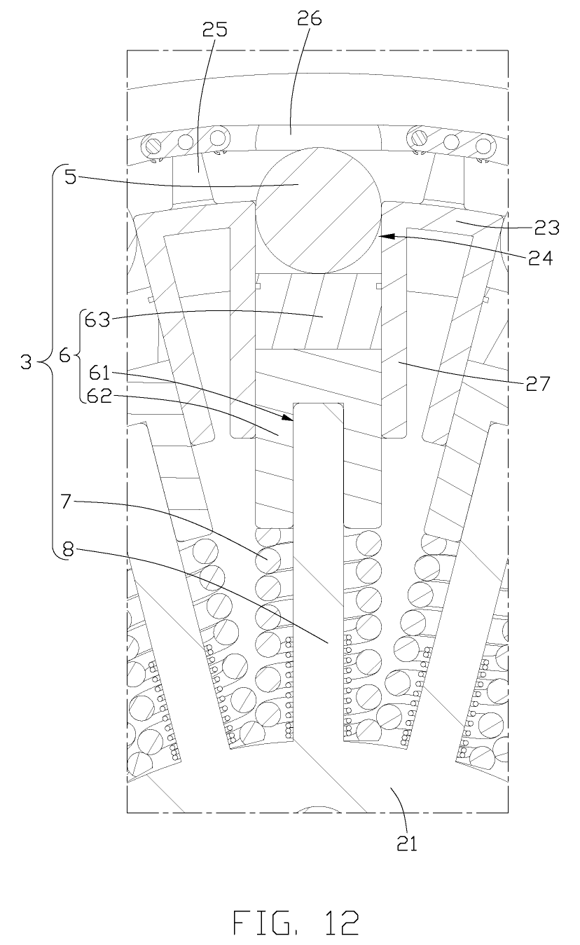

As shown in FIGS. 11 to 13, during the movement of the wheel structure 100, when the tire unit 1 is subjected to a force, on one hand, the tire 11 deforms under the force and compresses the piezoelectric elements 16. Then the piezoelectric elements 16 convert mechanical forces (such as pressure, tension, or acceleration) into a measurable voltage, generating electrical energy which is stored in the power storage module 200. On the other hand, the force applied to the tire unit 1 is transmitted to the metal ball 5, causing the metal ball 5 to push against the sealing portion 63. The sealing portion 63 further pushes the magnetic portion 62, causing the magnetic portion 62 to be closer to and compressing the metallic elastic coil 7. Thus, a current is generated according to Faraday's law of electromagnetic induction, and the power generation process may be achieved. The metallic elastic coil 7 is electrically connected to the power storage module 200, the generated electricity is ultimately stored in the power storage module 200.

As shown in FIGS. 2 and 13, when the force applied to the tire unit 1 is removed, on one hand, the tire 11 is no longer subjected to the force. The deformation of the tire 11 will revert to its original state, and the piezoelectric elements 16 will return to their initial state. Thereby, the mechanical forces (such as pressure, tension, or acceleration) may convert into measurable voltage to generate electrical energy which can be stored in the power storage module 200. On the other hand, relying on the elasticity of the metallic elastic coil 7, the magnetic portion 62, the sealing portion 63, and the metal ball 5 are pushed back to their initial positions. At this state, the magnetic portion 62 moves away from the metallic elastic coil 7, generating a current again according to Faraday's law of electromagnetic induction and achieving another power generation process.

The present disclosure provided mechanical kinetic energy recovery, wherein the deformation and gravitational changes during the rotation of the tire 11 can drive the first power generation units 3 and second power generation units 12 to convert mechanical energy into electrical energy, to provide additional power for electric vehicles. By setting a plurality of first power generation units 3, the wheel structure 100 can convert the mechanical energy into electrical energy for storage during movement. Thereby, self-generation with a high mechanical energy conversion rate can be achieved, the power generation may be effectively increased, and the efficient recovery and utilization of kinetic energy may also be realized. Moreover, the structure of the first power generation unit 3 is simple, and the operation of the first power generation unit 3 is not restricted by the direction of the applied force, enabling the first power generation unit 3 to convert forces received from various directions. Additionally, by setting the second power generation units 12 in the tire 11, the mechanical energy can be further converted into electrical energy. The second power generation unit 12 has high mechanical strength and high electrical power output, further achieving the full recovery of mechanical energy.

The first power generation unit 3 cooperates with the second power generation unit 12 in the present disclosure. That is, the coil power generation technology based on Faraday's law of electromagnetic induction is integrated with the piezoelectric element power generation system operating in compression mode. Therefore, the power generation efficiency of the wheel structure 100 is enhanced, the recovery and utilization of surplus kinetic energy is achieved, and energy conservation and carbon reduction can be realized.

Referring to FIG. 13, a vehicle 1000 with the self-powered wheel structure 100 is provided according to an embodiment of the present disclosure. The vehicle 1000 includes a frame 300, the power storage module 200, and the self-powered wheel structure 100 disposed on the frame 300. The self-powered wheel structure 100 is electrically connected to the power storage module 200. By employing the self-powered wheel structure 100, the kinetic energy generated during the movement of the vehicle 1000 can be converted into electrical energy and stored by the vehicle 1000, thereby effectively improving energy utilization efficiency. In some embodiments, the vehicle 1000 can be, but not limited to an electric vehicle.

The self-powered wheel structure 100 is not only suitable for electric vehicles but can also be applied to any wheeled or rotatable vehicles, such as trucks, wheeled robots, and tracked systems.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A self-powered wheel structure comprising:
a tire unit;
a hub unit comprising a hub, a spoke, and a rim, the hub disposed at a center of the rim, the rim coaxially arranged with the hum, the spoke connected between the hub and the rim in a radiating manner along a radial direction, wherein the tire unit is disposed on outer side of the rim, the tire unit and the rim cooperatively define a cavity for containing gas; and
a plurality of first power generation units, each of the plurality of first power generation units comprising a metal ball, a magnetic member, and a metallic elastic coil arranging sequentially along the radial direction, wherein the metal ball is movably disposed within the cavity, the rim defines a through-hole corresponding to the metal ball, the through-hole is connected to the cavity, the magnetic member penetrates through the through-hole and is movable along the radial direction, two ends of the metallic elastic coil are abutted against the magnetic member and the hub, respectively, and the metallic elastic coil is electrically connected to a power storage module.

2. The self-powered wheel structure according to claim 1, wherein the tire unit comprises a tire and a plurality of second power generation units, the tire comprises a rubber layer, a functional layer, and an airtight layer sequentially disposed from an outer side to an inner side of the tire, the plurality of second power generation units is disposed in the functional layer, each of the plurality of second power generation units comprises a plurality of piezoelectric elements, and the plurality of piezoelectric elements is configured to electrically connect to the power storage module.

3. The self-powered wheel structure according to claim 2, wherein each of the plurality of piezoelectric elements is a piezoelectric ceramic chip or a PVDF diaphragm.

4. The self-powered wheel structure according to claim 1, wherein the magnetic member comprises a magnetic portion and a sealing portion, the sealing portion is disposed on an end of the magnetic portion away from the hub, and the sealing portion is movably sealed in the through-hole.

5. The self-powered wheel structure according to claim 1, each of the plurality of first power generation units further comprising a guide rod disposed on the hub, wherein the guide rod extends along the radial direction, the metallic elastic coil is sleeved on the guide rod, the magnetic member is disposed on an end of the guide rod away from the hub, and is movable along the guide rod.

6. The self-powered wheel structure according to claim 5, wherein an end of the magnetic member close to the hub defines a limiting slot, an opening of the limiting slot faces toward the hub, and the guide rod extends into the limiting slot.

7. The self-powered wheel structure according to claim 1, wherein the hub unit further comprises a plurality of fixed sleeves disposed on a surface of the rim facing the hub, the plurality of fixed sleeves is disposed outside the through-hole, and the magnetic member is movably disposed within a corresponding one of the plurality of fixed sleeves.

8. The self-powered wheel structure according to claim 1, wherein the hub unit further comprises a plurality of posts and a plurality of limiting rings, the plurality of posts and the plurality of limiting rings are disposed on a surface of the rim adjacent to the cavity, one of the plurality of limiting rings is installed between two adjacent of the plurality of posts, and the metal ball of each of the plurality of first power generation units is movably disposed in a corresponding one of the plurality of limiting rings.

9. The self-powered wheel structure according to claim 4, wherein the magnetic portion is a magnet, and the metallic elastic coil is a metal spring coil.

10. The self-powered wheel structure according to claim 7, wherein the plurality of fixed sleeves and the rim are integrally formed.

11. A vehicle comprising:
a frame;
a power storage module; and
a self-powered wheel structure electrically connected to the power storage module, the self-powered wheel structure comprising:
a tire unit;
a hub unit comprising a hub, a spoke, and a rim, the hub disposed at a center of the rim, the rim coaxially arranged with the hum, the spoke connected between the hub and the rim in a radiating manner along in a radial direction, wherein the tire unit is disposed on outer side of the rim, the tire unit and the rim cooperatively define a cavity for containing gas; and
a plurality of first power generation units, each of the plurality of first power generation units comprising a metal ball, a magnetic member, and a metallic elastic coil arranging sequentially along the radial direction, wherein the metal ball is movably disposed within the cavity, the rim defines a through-hole corresponding to the metal ball, the through-hole is connected to the cavity, the magnetic member penetrates through the through-hole and is movable along the radial direction, two ends of the metallic elastic coil are abutted against the magnetic member and the hub, respectively, and the metallic elastic coil is electrically connected to a power storage module.

12. The vehicle according to claim 11, wherein the tire unit comprises a tire and a plurality of second power generation units, the tire comprises a rubber layer, a functional layer, and an airtight layer sequentially disposed from an outer side to an inner side of the tire, the plurality of second power generation units is disposed in the functional layer, each of the plurality of second power generation units comprises a plurality of piezoelectric elements, and the plurality of piezoelectric elements is configured to electrically connect to the power storage module.

13. The vehicle according to claim 12, wherein each of the plurality of piezoelectric elements is a piezoelectric ceramic chip or a PVDF diaphragm.

14. The vehicle according to claim 11, wherein the magnetic member comprises a magnetic portion and a sealing portion, the sealing portion is disposed on an end of the magnetic portion away from the hub, and the sealing portion is movably sealed in the through-hole.

15. The vehicle according to claim 11, each of the plurality of first power generation units further comprising a guide rod disposed on the hub, wherein the guide rod extends along the radial direction, the metallic elastic coil is sleeved on the guide rod, the magnetic member is disposed on an end of the guide rod away from the hub, and is movable along the guide rod.

16. The vehicle according to claim 15, wherein on an end of the magnetic member close to the hub defines a limiting slot, an opening of the limiting slot faces toward the hub, and the guide rod extends into the limiting slot.

17. The vehicle according to claim 11, wherein the hub unit further comprises a plurality of fixed sleeves disposed on a surface of the rim facing the hub, the plurality of fixed sleeves is disposed outside the through-hole, and the magnetic member is movably disposed within a corresponding one of the plurality of fixed sleeves.

18. The vehicle according to claim 11, wherein the hub unit further comprises a plurality of posts and a plurality of limiting rings, the plurality of posts and the plurality of limiting rings are disposed on a surface of the rim adjacent to the cavity, one of the plurality of limiting rings is installed between two adjacent of the plurality of posts, and the metal ball of each of the plurality of first power generation units is movably disposed in a corresponding one of the plurality of limiting rings.

19. The vehicle according to claim 14, wherein the magnetic portion is a magnet, and the metallic elastic coil is a metal spring coil.

20. The vehicle according to claim 17, wherein the plurality of fixed sleeves and the rim are integrally formed.
